(19) United States
(12) Patent Application Publication
(10) Pub. No.: US 2006/0276200 A1
(43) Pub. Date: Dec. 7, 2006

(54) Mobile and wireless network architecture for law enforcement

(76) Inventors: Sridhar Radhakrishnan, Norman, OK (US); Moshe Gutman, Norman, OK (US); Darren Dowjack White, Edmond, OK (US); Kyle Joseph Abbott, Norman, OK (US)

Correspondence Address: DUNLAP, CODDING & ROGERS P.C., PO BOX 16370, OKLAHOMA CITY, OK, 73113, US

(21) Appl. No.: 11/435,798

(22) Filed: May 17, 2006

Related U.S. Application Data
(60) Provisional application No. 60/681,732, filed on May 17, 2005.

(51) Int. Cl. H04Q 7/20

(52) U.S. Cl. 455/456.1; 455/457

(57) ABSTRACT

An officer communication system and method for providing a peer-to-peer mobile and wireless network software architecture which allows mobile units or clients, administrators, and/or dispatchers to communicate information that is pertinent to law enforcement, or related services. Such information includes text, images and/or audio. For example, such information can be indicative of an officer's or suspect's location (e.g., latitude, longitude, altitude, or intersection), speed and direction of travel, an officer's assignment details, national or local bulletins, the homeland security alert level, a “live” video feed, maps or directions, etc. In one embodiment, the system via a client user interface allows for the automatic readout of intersections during a chase, and the marking on maps of special locations (e.g. locations where evidence can be found).

### CROSS-REFERENCE TO RELATED APPLICATIONS

The present patent application claims priority to the provisional patent application identified by U.S. Ser. No. 60/681,732 filed on May 17, 2005. The entire content of the afore mentioned provisional patent application is hereby incorporated herein by reference.

### STATEMENT REGARDING FEDERALLY SPONSORED RESEARCH AND DEVELOPMENT

Not applicable.

### BACKGROUND OF THE INVENTION

Police personnel in pursuit or emergency response personnel currently use hand-held radios to verbally broadcast their location to the other officers or emergency response personnel. In particular, officers in pursuit have to drive at high rates of speed with one hand and continually update his location and direction of travel on the hand-held radio. This creates a very unsafe environment for police personnel.

A peer-to-peer network is generally characterized by the direct sharing of computer resources rather than require an intermediate server. Peer-to-Peer networks and networks requiring a server are known and have been used in various different venues.

### SUMMARY OF THE INVENTION

In general, the present invention relates to a communication system and method for providing a peer-to-peer and client/server mobile and wireless network software architecture which allows mobile units to communicate information that is pertinent to law enforcement, first responders or related services. Such information includes text, images and/or audio. For example, such information can be indicative of an officer's, suspect's, incident, or accident location (e.g., latitude, longitude, altitude, or intersection), speed and direction of travel, an officer's assignment details, national or local bulletins, the homeland security alert level, a “live” video feed, maps or directions, etc. In one embodiment, the system allows for the automatic readout of intersections during a chase, and the marking on maps of special locations (e.g. locations where evidence can be found).

### BRIEF DESCRIPTION OF THE SEVERAL DRAWINGS

FIG. 1 is a block diagram view of an officer communication system constructed in accordance with the present invention.

FIG. 2 is a diagrammatic view of one embodiment of a method for sending messages within the officer communication system.

FIG. 3 is a diagrammatic view of one embodiment of a method for sending messages within the officer communication system wherein the message includes video information.

FIG. 4 is a diagrammatic view of one embodiment of a method for sending messages within the officer communication system wherein the message includes pursuit status and intersection information.

FIG. 5 is a diagrammatic view of one embodiment of a method for sending messages within the officer communication system wherein the message includes pursuit status information.

FIG. 6 is a diagrammatic view of one embodiment of a method for sending messages within the officer communication system wherein the message includes alert level information.

FIG. 7 is a graphical representation of one embodiment of a Log In screen of a user interface constructed in accordance with the present invention.

FIG. 8 is a graphical representation of one embodiment of a main screen of the user interface.

FIG. 9 is a graphical representation of one embodiment of tools of a Messages Panel of the user interface.

FIG. 10 is a graphical representation of one embodiment of a Online Officer List of the user interface.

FIG. 11a is a graphical representation of one embodiment of tools of a Maps Panel of the user interface.

FIG. 11b is a graphical representation of one embodiment of a aerial map in the Maps Panel of the user interface.

FIG. 11c is a graphical representation of one embodiment of a street map in the Maps Panel of the user interface.

FIG. 12a is a graphical representation of one embodiment of tools of a Pictures Panel of the user interface.

FIG. 12b is a graphical representation of one embodiment of file icons for the user interface.

FIG. 12c is a graphical representation of one embodiment of the Pictures Panel of the user interface.

FIG. 13 is a graphical representation of one embodiment of tools of a Settings Panel of the user interface.

FIG. 14 is a graphical representation of one embodiment of textual and pictorial representations of a plurality of security alert levels and a pursuit mode button for the user interface.

FIG. 15 is a graphical representation of a plurality of short cut keys for the user interface.

FIG. 16 is a diagrammatic view of another embodiment of an officer communication system using peer-to-peer communication.

### DETAILED DESCRIPTION OF THE PREFERRED EMBODIMENTS

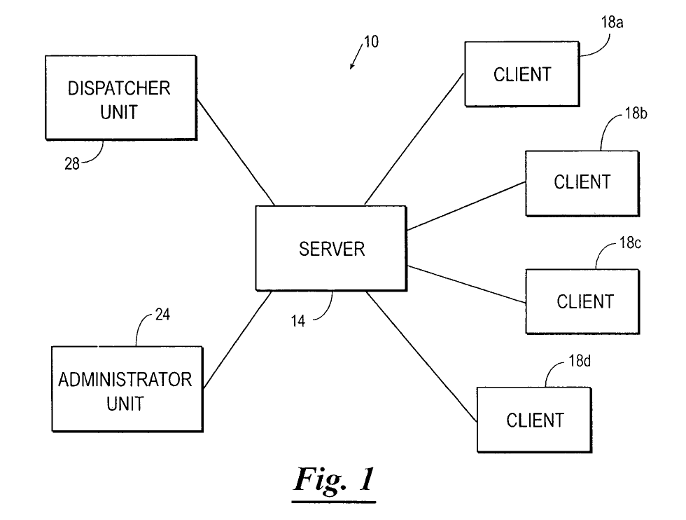

Referring now to FIG. 1, shown therein and designated by the reference numeral 10 is one embodiment of an officer communication system constructed in accordance with the present invention. The officer communication system 10 includes a server 14 and a plurality of clients 18. Only four clients 18 of the officer communication system 10 are shown and are designated by the reference numerals 18a, 18b, 18c and 18d in FIG. 1 for purposes of clarity. Although only four clients 18 are discussed herein for purposes of illustration, it should be understood that the present invention contemplates that any number of clients 18 can be included in the officer communication system 10 in accordance with the present invention.

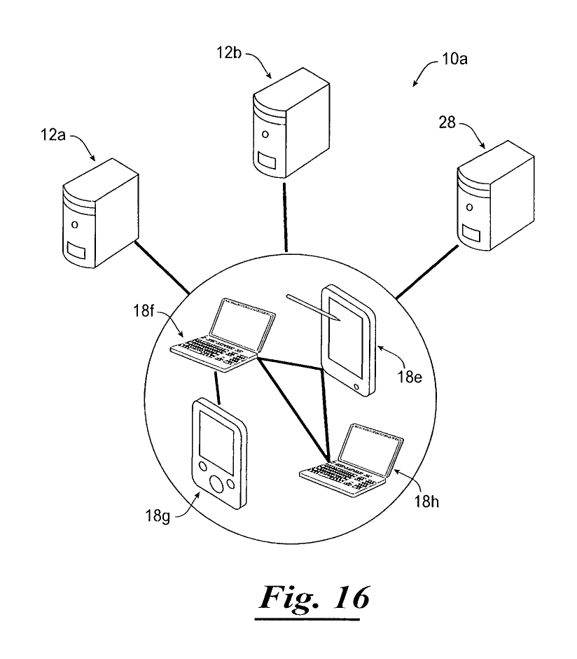

Referring now to FIG. 16, shown therein and designated by the reference numeral 10a is another embodiment of an officer communication system 10 constructed in accordance with the present invention using a peer-to-peer network. The peer-to-peer officer communication system 10a (peer-to-peer) includes a plurality of clients 18. Only four clients 18 of the peer-to-peer system 10a are shown and are designated by the reference numerals 18e, 18f, 18g and 18h in FIG. 16 for purposes of clarity. Although only four clients 18 are discussed herein for purposes of illustration, it should be understood that the present invention contemplates that any number of clients 18 can be included in the peer-to-peer system 10a in accordance with the present invention. It is to be noted that officer communication systems 10 and 10a are similar in function and construction with the exception of the system architecture. In system 10a the clients 18 communicate directly with one another via network connections. In system 10 the clients 18 communicate with one another through a server(s) 14 via network connections. For purposes of brevity, the following description primarily focuses on system 10.

In general, each of the clients 18 is a mobile computer system associated with a user, such as an officer in the field. For instance, the client 18 can be provided in the officer's vehicle, kept on the officer's person (e.g. via a clip, belt, carrying case, etc), or in combinations thereof. In one embodiment, each of the clients 18 of the officer communication system 10 includes a portable computer, a GPS system, a wireless modem (e.g., CDPD, CDMA, or GPRS), and at least one input and/or output device, such as a touch screen monitor, a keyboard or keypad, a microphone/speaker system, a camera, and combinations thereof.

The clients 18 are capable of receiving data signals or “messages” from the server 14 or other clients, and then outputting the information in the messages in a manner perceivable by the officers, either visually or audibly, or both. The clients 18 are also capable of transmitting messages to the server 14, which can then be transmitted by the server 14 to other clients 18 or devices and the clients 18 are also capable of sending messages to other clients 18 directly as in the case of the peer-to-peer architecture shown in FIG. 16. Such messages are indicative of text, images and/or audio. For example, the messages can include information such as an officer's or suspect's location (e.g., latitude, longitude, altitude, or intersection), speed, direction of travel, “live” video feed, information from any database 12, such as any crime information database or information servers, location of accidents or incidents that require the attention of first responders, and others. The clients 18 can also provide the officers with access to other internal or external databases, programs, networks, etc.

In one embodiment, the officer communication system 10 further includes at least one administrator unit 24. Although only one administrator unit 24 is shown in FIG. 1 and discussed herein for purposes of clarity and illustration, it should be understood that the present invention contemplates that any number of administrator units 24 can be included in the communication system 10 in accordance with the present invention.

In general, the administrator unit 24 is a computer system associated with an administrative entity which allows the administrative entity to send messages to the clients 18 via the server 14. For example, the messages can include information such as the homeland security alert level, national or local bulletins and warnings, etc. In one preferred embodiment, the administrator unit 24 interfaces with the server 14 via a console on a website so that the administrator unit 24 can be located remotely from the server 14.

Further, in one embodiment, the officer communication system 10 also includes at least one dispatcher unit 28. Although only one dispatcher unit 28 is shown in FIG. 1 and discussed herein for purposes of clarity and illustration, it should be understood that the present invention contemplates that any number of dispatcher units 28 can be included in the communication system 10 in accordance with the present invention.

In general, the dispatcher unit 28 is a computer system associated with a dispatcher for the officers associated with the clients 18. The dispatcher unit 28 allows the dispatcher to send and receive messages from the clients 18 via the server 14. For example, the messages sent by the dispatcher via the dispatcher unit 28 can include information such as assignment details, station alerts and updates, national or local bulletins, etc. The clients 18 can also send messages to the dispatcher unit 28 via the server 14, such as for example live video streams, assignment reports, status updates, emergency calls, 10-codes, etc.

The server 14 of the officer communication system 10 is a computer system that is capable of receiving, storing and transmitting data to and from the clients 18, the administrator unit 24, and the dispatcher unit 28. The server 14 can be connected to the clients 18, the administrator unit 24, and the dispatcher unit 28 via any suitable communication link or system, such as for example busses, local area networks, wide area networks, telephone links, cable links, satellite links, radio links, fiber optic links, infrared links, etc. Preferably, the server 14 is connected to the clients 18 via at least one wireless link so that the clients 18 can be mobile.

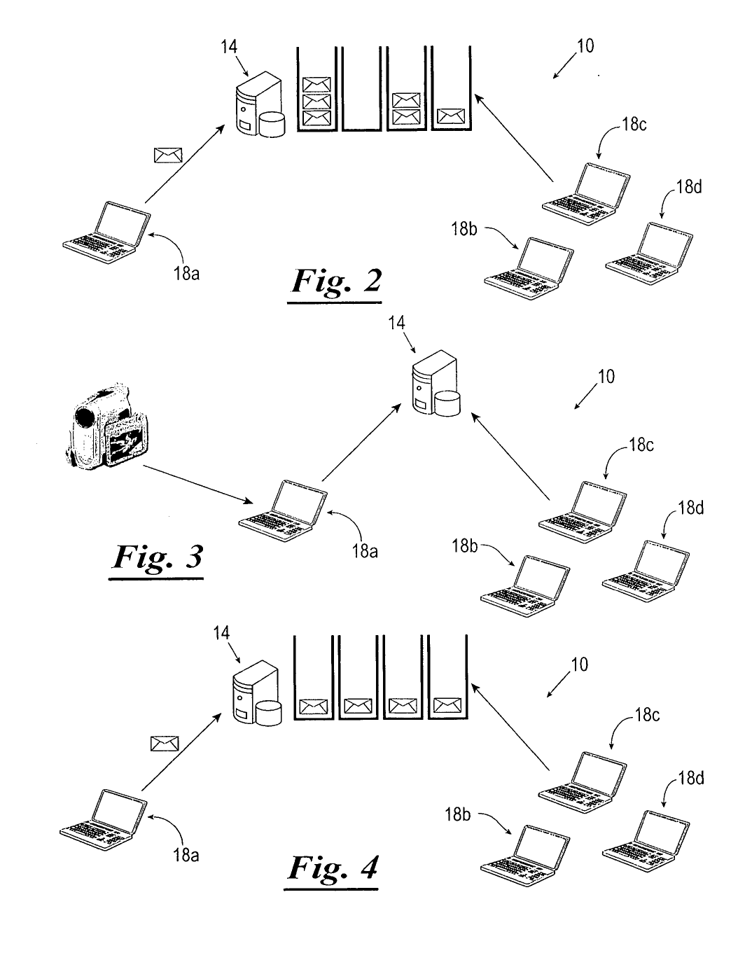

In one embodiment, communication between the server 14, the clients 18, the administrator unit 24, and the dispatcher unit 28 is based on a “mailbox” system, as shown for example in FIG. 2 (wherein only the clients 18 and the server 14 are shown for purposes of clarity). When one of the clients 18, the administrator unit 24, or the dispatcher unit 28 sends a message to the server 14, the server 14 selectively places the message in the mailboxes of intended recipient clients 18 (or other recipients, such as for example the dispatcher unit 28). The recipient clients 18 can then automatically or upon request check their mailboxes, i.e. download and obtain the message. The recipient clients 18 can be indicated to the server 14 by the transmitting client 18, administrator unit 24, or dispatcher unit 28 (e.g., according to a selection of a user from a list), or the recipients can be determined by the server 14 (e.g., all clients 18, or only clients 18 that are within a certain area or vicinity).

For example, if the officer associated with the client 18a wants to transmit streaming video to other officers, such as those associated with clients 18b, 18c or 18d (or the dispatcher unit 28), the client 18a will indicate the intended recipients and then start sending messages (or video frames) to the server 14, as shown for example in FIG. 3 (wherein only the clients 18 and the server 14 are shown for purposes of clarity). The server 14 then places the video frames in the appropriate recipient mailboxes. The recipient clients 18b, 18c, and 18d read their mailboxes to receive the video frames, and then output the video frames to the officers in an essentially real-time manner (e.g. one video frame per second as transmitted by the client 18a).

In the embodiment of the present officer communication system referred to in FIG. 16, the peer-to-peer system 10a operates without a dispatcher unit 28, or dispatcher computer system. While using the peer-to-peer system 10a the information is exchanged among the clients 18 continuously at frequent intervals of time. For this purpose, each client 18 maintains a message number that indicates the most recent message it has received so far. When a user sends a message it increments the message number and it sends the message with the message number to all the clients 18 that can receive the message. Clients 18 compare the message number it received along with the message number they have stored. If the stored message number is greater than the received message number, then the message is ignored. Otherwise the client 18 processes the message, changes the stored message number to the received message number and sends the message to all the clients 18 that can receive the message. This peer-to-peer embodiment of the proposed peer-to-peer system 10a allows the peer-to-peer system 10a to work in the absence of a dispatcher unit 28, such as a server.

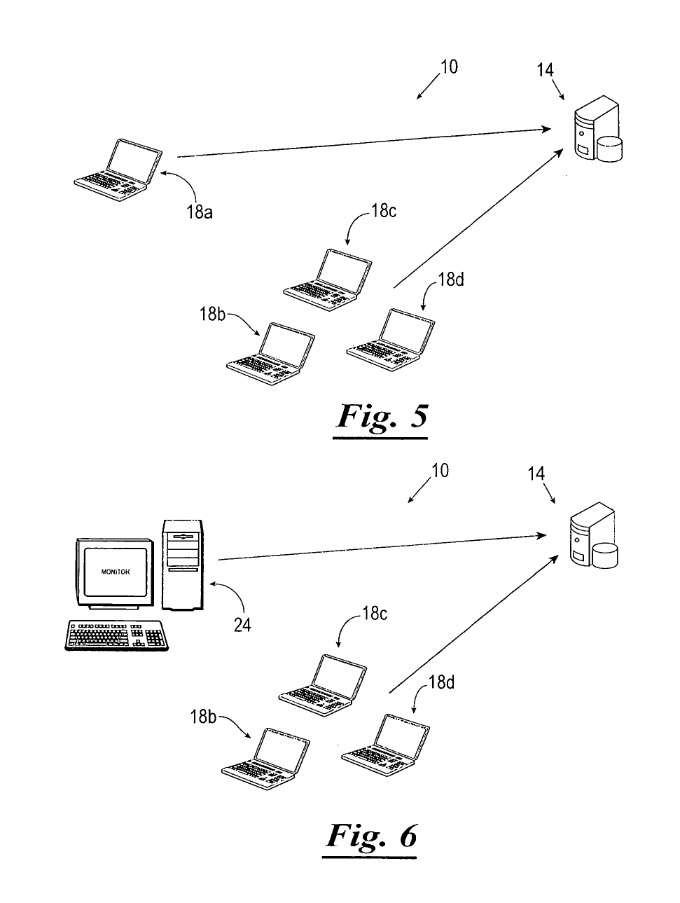

In another example, as shown in FIGS. 4 and 5, if the officer associated with the client 18a is “in pursuit” of a suspect, then the officer can indicate to the server 14 via the client 18a that the officer is in pursuit by transmitting one or more pursuit status messages to the server 14. The server 14 can then transmit the pursuit messages to the mailboxes of the other clients 18b, 18c and 18d so that the other officers can receive information relating to the pursuit. In one embodiment, the pursuit status messages include information indicative of the current location of the client 18a (and thus the officer associated therewith). For example, the pursuit status messages can provide location information, which can then be broadcasted to the other officers via their clients 18b, 18c and 18d. In one embodiment, the location information in the pursuit status message is in the form of an intersection designation, as determined from the GPS coordinates indicated by the GPS system of the client 18a. Further, the pursuit status message can include other relevant information concerning the pursuit. For example, the pursuit status message can include the officer's current speed and direction of travel (e.g., as inputted to the client 18a by the officer or from the vehicle's control panel. Other types of information may also be included into the pursuit status messages, such as for example a description of the suspect and suspect's vehicle, duration of the pursuit, etc.

Once the pursuit status messages are received, the clients 18b, 18c and 18d can output the location information to the other officers. In one embodiment, the clients 18b, 18c, and 18d can convert text data into audio or speech data so that the location information is “read aloud” to the other officers. In another embodiment, the clients 18b, 18c and 18d can display the location information visually, such as tracking a marker on a map.

Shown in FIG. 6 is yet another example of a use for the officer communication system 10 (wherein only the clients 18b, 18c, and 18d and the server 14 are shown for purposes of clarity). If the administrative entity associated with the administrator unit 24 wants to inform the officers of the current homeland security alert level, the administrative entity can set the current alert level via the administrator unit 24 by inputting information indicative of the current alert level into the server 14. The server 14 updates its database with the current alert level information and then adds an alert status message to each of the mailboxes of the clients 18. The clients 18 then read their mailboxes to receive the alert status message in the dispatcher clients model or a single client propagates the message to other clients the Peer-to-peer architecture, and display the information relating to the alert level to the officers.

As discussed above, each of the clients 18 of the officer communication system 10 can include a portable computer, a GPS system, a wireless modem (e.g., CDPD, CDMA, or GPRS), and at least one input and/or output device, such as a touch screen monitor, a keyboard or keypad, a microphone/speaker system, a camera, and combinations thereof. In one embodiment, each of the clients 18 further includes software so as to provide the officer using the client 18 with a user interface, referred to herein as an “OfficerAssistant.”

For each client 18, the OfficerAssistant functions similarly. Therefore, for purposes of clarity, the OfficerAssistant will be generally discussed further below with reference to one client 18a.

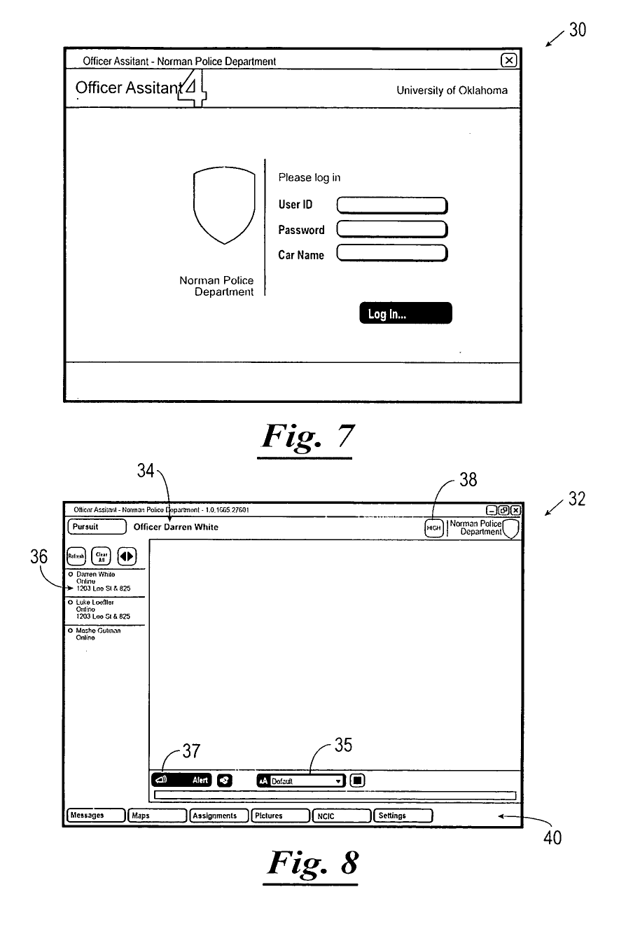

When the OfficerAssistant is first initiated, the officer using the client 18a is provided with a “Log In” screen 30 on the touch screen monitor of the client 18a, as shown for example in FIG. 7. The Log In screen 30 prompts the officer to log onto the officer communication system 10 via the client 18a by entering a username, password, and car number into the appropriate fields provided in the OfficerAssistant. When a client 18a is logged onto the officer communication system 10, the client 18a indicates the presence of the officer on the officer communication system 10 by broadcasting this information to the other clients 18, the administrator 24 and/or the dispatcher 28 via the server 14. In one embodiment, the server 14 sends messages indicating the presence or absence of one of the clients 18 using network packets that are sent at regular intervals of time to all currently logged on clients 18, administrator 24, and/or dispatcher 28. As such, when the officer is present, the mobile peer-to-peer architecture of the present invention allows the clients 18, the administrator 24, and/or the dispatcher 28 to readily identify the presence of others in the officer communication system 10, and communicate therewith.

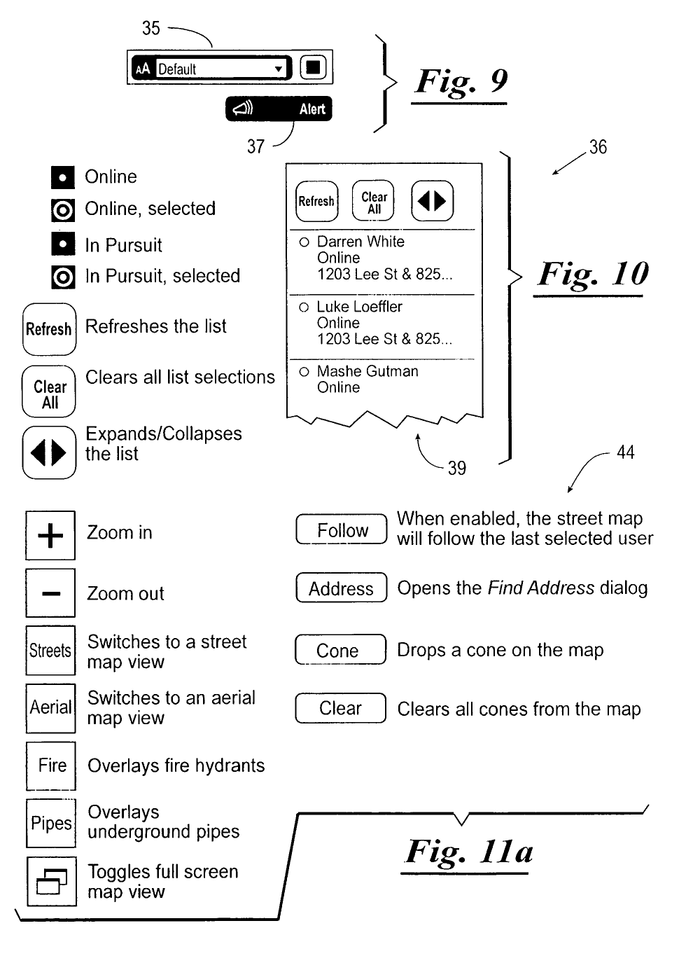

Once the officer has logged in, a main screen 32 of the OfficerAssistant is provided to the Officer, as shown for example in FIG. 8. In general, the main screen 32 displays information and allows access to other tools or resources which are available to the officer using the client 18a. In one embodiment, the main screen 32 includes a “Name/Alert Scroller” indicator 34 which displays the name of the officer currently logged onto the client 18a. The main screen 32 also includes an “Online Officer Viewer” indicator 36 which displays the names of the other officers (or the dispatcher) which are logged into the officer communication system 10. The Online Officer Viewer indicator 36 can also display other information, such as the location of the other officers and whether the Officer is in pursuit mode, such as for example by a status icon, as shown best in FIG. 10. Also, the Online Officer View can organize mobile units based on beat characteristics, such as for example by areas of patrol or by departments.

As shown in FIG. 8, the OfficerAssistant can also include a Homeland Security Alert Level indicator 38 which displays the current alert level. The current alert level can be displayed using text (e.g., “Low”, “Guarded”, “Elevated”, “High” or “Severe”) and/or pictorially (e.g., an icon with a color code, such as green, blue, yellow, orange, or red), as shown best in FIG. 14.

Further, the OfficerAssistant includes a “Navigation Bar” 40 which includes links (e.g., buttons, tabs, etc.) to other resources which can be accessed in the main screen 32. Preferably, once an officer selects or clicks on a link via the Navigation Bar 40, the resource is displayed in a sub-screen within the main screen. In one embodiment, the Navigation Bar 40 includes links for a “Messages Panel”, a “Maps Panel”, an “Assignments Panel”, a “Pictures Panel”, a “NCIC” Panel, and a “Settings Panel”.

The Messages Panel allows the officer using the client 18a to enter and transmit text messages to other users via the server 14, and receive and view messages which were forwarded from other users by the server 14. In one embodiment, the Message Panel is by default the first sub-screen displayed in the main screen 32 after the officer has logged onto the client 18a, as shown for example in FIG. 8. To send a message, the officer indicates a recipient, enters the message into a text field of the Message Panel (e.g. via a keyboard or microphone), and presses an “Enter” key to transmit the message to the server 14 so that the server 14 can deliver the message to the selected recipient(s). In one embodiment, the officer indicates a recipient by selecting a user from an “Online Officer List” 39 displayed in the Online Officer Viewer indicator 36 of the main screen (e.g. via the touch screen monitor). Preferably, once the officer selects a user from the Online Officer List, a visual indicator denotes that the user has been selected (e.g., by a white circle around the status icon of the user), as shown best in FIG. 10. The Online Officer List 39 can also include buttons and option tools to facilitate the selection or de-selection of a user from the list. For example, as shown best in FIG. 10, a “Refresh” button can be provided to allow the officer to refresh the list so as to display a more current list of online users, a “Clear All” button can be provided to allow the officer to clear all selections previously made by the officer, and a “Expands/Collapse” button can be provided to allow the officer to expand and collapse the list or portions thereof.

Alternatively, if the officer wants to send a message to all online users, the officer can indicate that the message is a broadcast message by using a “Broadcast” button provided in the Message Panel, as shown best in FIG. 8. The Message Panel can further include other buttons and tool options to facilitate the entering and transmitting of text messages. For example, as best shown in FIG. 9, the Message Panel can include a font tool bar 35 for controlling the font style and color for outgoing messages. In one embodiment, the Message Panel also includes an “Alert” feature 37 which, when enabled, will send the message as an alert message that will scroll across the top of the main screen of the recipient clients 18 and create an audible alert alarm outputted by the recipient clients 18 to alert the other officers of the incoming alert message.

In one embodiment, the Messages Panel also includes a mailbox indicator which displays messages (or portions thereof) sent from other users (e.g., other officers). In one embodiment, the officer can select a message to be displayed fully in a viewer in the Messages Panel. In another embodiment, the messages are automatically displayed by the client 18a in the viewer. Further, text messages sent to the client 18a can be “read aloud” using text-to-speech engines of the client 18a.

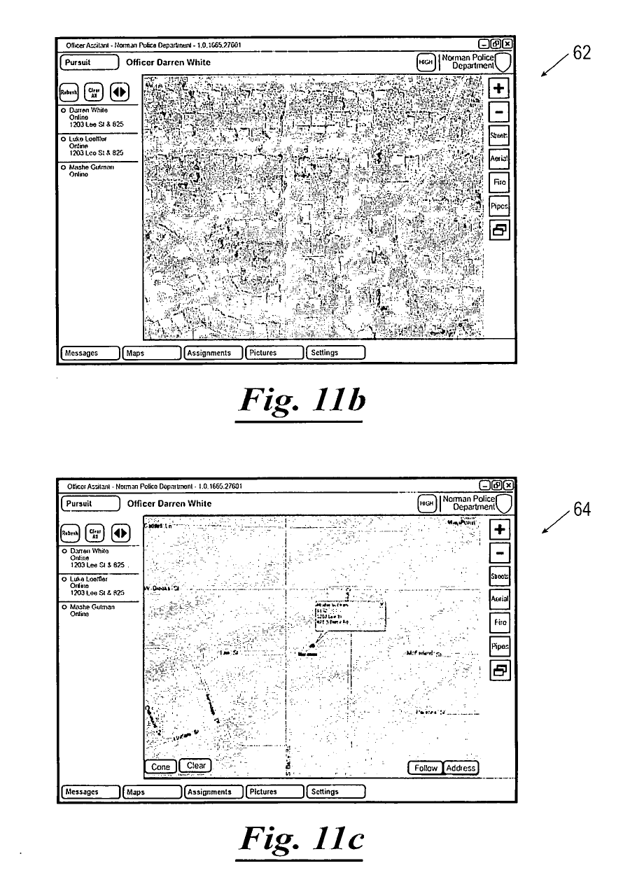

The Maps Panel 44 allows the officer to access maps, as shown for example in FIGS. 11b and 11c. The maps can be stored on the client 18a or remotely stored on the server 14 or other remote computer (e.g., a computer on the internet). For example, the officer can access a previously created street map or aerial view of the city. Also, the system can be extended to allow the integration of more “real-time” aerial and satellite images.

Preferably, the Maps Panel 44 includes buttons and tool options to facilitate the displaying of maps and objects located therein, as shown for example in FIG. 11a. In one embodiment, the Maps Panel includes a toolbar having a “+” button which zooms in on the map, a “−” button which zooms out of the map, and pan buttons that allow scrolling of the map in the North, South, East and West directions. The Maps Panel further includes a “Streets” button which switches to a street map view 64, an “Aerial” button which switches to an aerial map view 62, a “Fire” button which overlays fire hydrant markers on the current map view to indicate the locations of fire hydrants, a “Pipes” button which overlays underground pipes markers on the current map view to indicate the locations of underground pipes, and a button that toggles the map view between a full screen view and a downsized view.

In one embodiment, the Maps Panel 44 further includes a “Follow” option that when enabled, will display a map and a marker that dynamically follows a selected user (such as another officer in pursuit of a suspect). Further, the Maps Panel 44 can include an “Address” option that allows the officer to enter an address so that the location can be indicated by a marker on a map, or so that the officer can obtain directions to the address textually, visually and/or audibly.

Further, in one embodiment, the Maps Panel 44 also includes a “Cone” option that allows the officer to “drop a cone,” or electronically mark a point, on a map so as to graphically indicate a location of interest on the map displayed on the client 18a, and well as maps displayed on other online clients 18. For example, if a suspect throws an object out of his car window while being pursued by the officer, the officer can drop a cone on a map using the Cone option of the Maps panel 44 so as to mark that location. The cone also appears on every other online user's map so that another officer can stop at that cone location to retrieve the evidence. The location of the cone on the map can either be user selected, or be determined by the officer's current location as indicated by the GPS system of the client 18a.

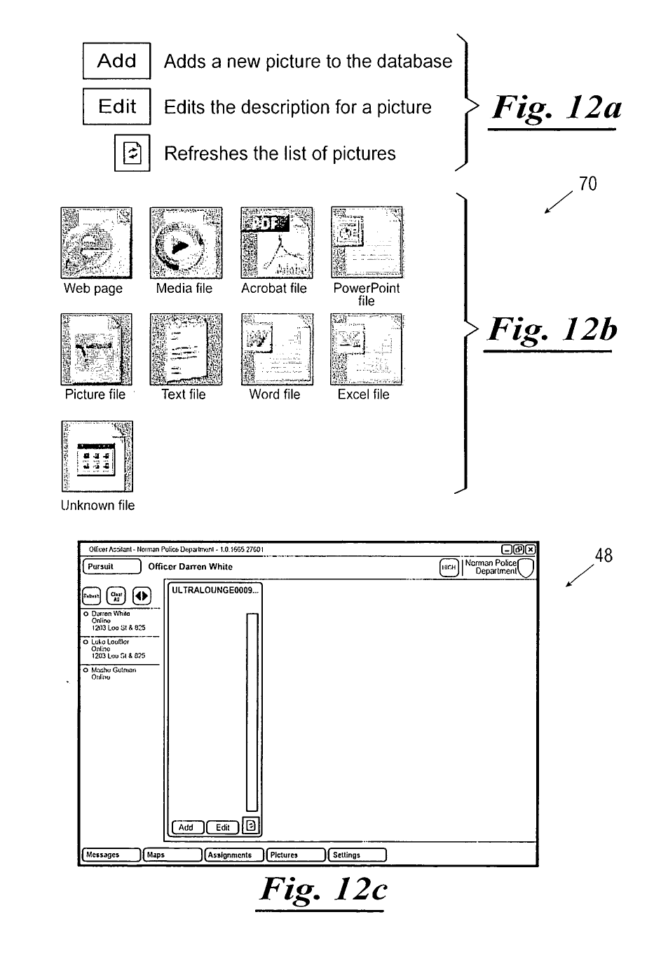

The Pictures Panel 48 allows the officer to send and receive image files 70, or files which include image data (e.g., pictures and videos). In one embodiment, the Pictures Panel 48 displays a list of image files 70 that can be accessed or downloaded by the officer, as shown for example in FIG. 12c. In one embodiment, the image files 70 are stored on a database of the server 14 and are accessible at all times to all online users via their clients 18. The Pictures Panel 48 can also include a “Refresh” option that allows the officer to refresh the list of pictures so as to obtain a more current listing of available image files 70, as shown best in FIG. 12a.

The image files 70 can be identified in the Pictures Panel 48 by a format icon (e.g., a pictorial representation of a web page file, media file, acrobat file, powerpoint file, picture file, text file, word file, excel file, or an unknown file) and a title, as shown for example in FIGS. 12b and 12c. Preferably, the image files 70 also have an editable text description associated therewith, as shown best in FIG. 12c. The description contains information regarding the contents of the files, and is displayed within the Pictures Panel 48 when the image file (or its icon) is selected. For example, if the image file 70 is a picture of a suspect, the description can include information describing the physical characteristics of the suspect and his/her alleged crimes, a warning that the suspect is “armed and dangerous,” instructions on how to proceed if the suspect is encountered, the date of the posting, etc. Also, the Pictures Panel 48 can include an “Edit” option that allows the officer to edit the description associated with an image file 70, as shown for example in FIG. 12a. Further, the Pictures Panel 48 can include an “Add” option that allows the officer to add a new file to the server database (e.g., via a scanner, camera, disk, etc.).

The NCIC Panel allows the officer to search the National Crime Information Center's database for information pertaining to any records or person, vehicle, or any other information relating to crime and related matters. The information sent from the NCIC database is displayed on the Officer's screen and any message that is tagged “hit” by the NCIC return information (indicating that for example a stolen vehicle) is sent to all the other officers via messages.

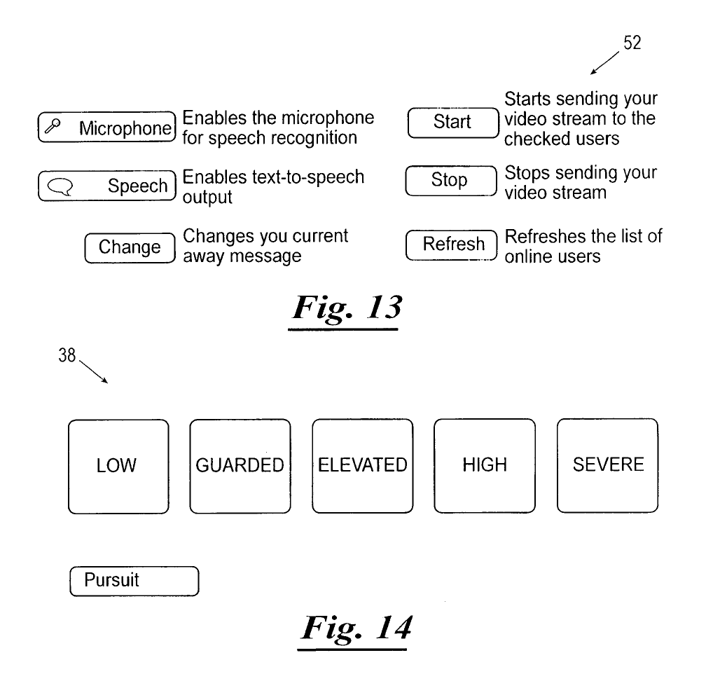

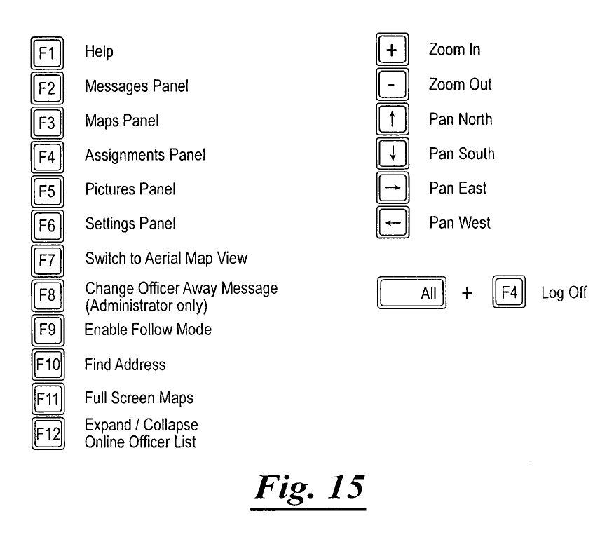

The Settings Panel 52 allows the officer to configure the OfficerAssistant interface. In one embodiment, as shown for example in FIG. 13, the Settings Panel 52 includes a “Microphone” option that enables the microphone of the client 18a for speech recognition, and a “Speech” option that enables text-to-speech output by the client 18a.

In one embodiment, the Settings Panel 52 also provides the officer access to the video features of the OfficerAssistant, which allows the officer to send a “live” video stream to selected recipients. The Settings Panel 52 can further include buttons and option tools to facilitate the transmittal of the video stream. In one embodiment, the Setting Panel 52 includes a “Start” button that causes the client 18a to start sending the video stream (e.g., from the camera of the client 18a) to the server 14 so that the server 14 can send the video stream messages to the selected recipient clients 18. The Setting Panel 52 also includes a “Stop” button which terminates the output of the video stream by the client 18a.

For example, if the officer wants to send a video stream, the officer first selects the recipients (for example by using the Online Officer List or the “Broadcast” button in a similar manner as describe above with reference to the Message Panel). The officer then selects or clicks the Start button to begin the video feed. To stop sending the video stream, the officer then selects or clicks the Stop button. Further, the Setting Panel 52 can include a “Refresh” button which allows the officer to refresh the list of online users and get a more current list from which recipients can be selected.

The Settings Panel 52 can further include a “Change” option that allows the officer to change a current away message of the officer.

In one embodiment, the OfficerAssistant further includes a “Pursuit” button, as shown best in FIGS. 8 and 14. The Pursuit button allows the officer to indicate that the officer is in pursuit mode. Once the Pursuit button is enabled, the location of the client 18a (and thus the officer) is broadcast to all online users. Preferably, the current intersection of the client 18a is broadcasted to the other clients 18 so that other officers can be alerted to where the pursuit is happening, and respond and aid in the pursuit if possible.

The Assignments Panel allows the officer to access assignment information. The assignment panel allows the officer to observe the various current first responder incidents that are taking place. For example, it will show the current accident location, the number of first responder units assigned to the accident, the type of first responder units assigned such as fire, ambulance, and police officer, the names or number of the units, and the nature of the accident.

The Assignments panel also allows the officer to receive assignments from supervisors. For example, an officer may be assigned to check on a suspect. This assignment will be sent to the officer and the officer will receive this under My Assignments Panel. A special “sound” will be initiated to indicate that an officer has received the assignment. After having received the assignment the officer, clicks a button the client screen named “Enroute” to indicate that the officer is on enroute to take care of the assignment. This will in turn send a message to the dispatcher in the system conceived in FIG. 10 or to all the clients in the system conceived in FIGS. 1 and 16. After arriving at the location, the officer will click the button named “Arrived” to indicate that the officer has arrived at the location where the assignment has been issued to the officer. Again a message is sent to the clients either through the dispatcher unit 28 or through other clients 18 as in the case of peer-to-peer system 10a. After the assignment is completed the officer clicks on the button named “Completed” and in a similar fashion to the “Enroute” and “Arrived” buttons a message is sent.

The Assignments panel further allows the Officer to click on current assignments in progress and have been assigned first responder units such as Police, Fire, and Ambulance, or assignments that have been created but no units have been assigned, and recently completed assignments. For each assigned unit the system uses color codes to indicate if the officer in route, arrived, or has completed the assignment. When an officer clicks on the assignment, it shows details of the assignment including a map that shows the location of the assignment.

The Assignments panel further allows the officer to create his/her own assignments. For example, the officer can create a traffic stop where a vehicle is stopped for running a stop sign. Upon clicking the traffic stop button, the field “Observed Violation At” is filled with the intersection where the traffic violation occurred is obtained using the GPS information and the map using Geocoding. After the vehicle that violated the traffic law stopped, the user clicks another button to indicate the location where the vehicle is stopped. This information and other information pertaining to traffic violation is sent as a message.

To facilitate the use of the tools and features of the OfficerAssistant, the Officer Assistant can also be provided with help windows and/or “short cut” keyboard keys, as shown for example in FIG. 14. Further, to terminate a session on the OfficerAssistant (and the client 18a), the Officer Assistant preferably includes a “Log Off” or “Close” button. After the officer has logged off, the Log In screen will return so as to allow the officer or another user to initiate a new session on the client 18a.

Although the present invention has been discussed herein with specific reference to law enforcement applications for purposes of illustration and understanding, it should be understood that the present invention can be used in other like service applications, such as for fire departments, EMSA, military units, etc, or for combinations thereof.

Although the foregoing invention has been described in some detail by way of illustration and example for purposes of clarity of understanding, it will be apparent to those skilled in the art that certain changes and modifications may be practiced without departing from the spirit and scope thereof, as described herein and in the above-referenced attachments. Also, it is to be understood that the phraseology and terminology employed herein is for purpose of description and should not be regarded as limiting.

1. A method of monitoring the location of service personnel or equipment, comprising:
providing a plurality of clients to the service personnel or the equipment; and
initiating a pursuit mode on at least one of the plurality of clients to cause the client to transmit a plurality of pursuit status messages to at least one other of the plurality of clients.

2. The method according to claim 1, wherein the client is accessed by service personnel.

3. The method according to claim 1, wherein the client comprises a mobile computer system.

4. The method according to claim 3, wherein the mobile computer system comprises a real-time location transmitting device, a wireless modem, at least one input device, and at least one ouput device.

5. The method according to claim 1, wherein the at least one pursuit status message is selected from the group consisting of a real-time location, intersection designation, service personnel's real-time speed, a direction traveled by service personnel, a description of pursued person, a description of pursued vehicle, and a duration of a pursuit.

6. The method according to claim 5, wherein the at least one pursuit status message is broadcast to the other plurality of clients in an audio form.

7. The method according to claim 5, wherein the at least one pursuit status message includes an identification of a service person associated with the particular client.

8. The method according to claim 1, wherein a server receives the pursuit status messages from the client and transmits the pursuit status messages to the plurality of clients.

9. The method according to claim 8, wherein the pursuit status messages comprise real-time location, real-time video, information from a crime information database, or a location of incident.

10. The method according to claim 1, wherein an electronic marker is broadcast from at least one of the plurality of clients to the other clients marking a real-time location along a route of pursuit.

11. The method according to claim 1, wherein the client transmits pursuit status messages to the other clients via a peer-to-peer network system.

12. The method according to claim 1, wherein the client periodically polls information from the other clients via a network.

13. The method according to claim 1, wherein the client periodically polls information from the other clients through a server via a network.
